(19) United States
(12) Patent Application Publication
(10) Pub. No.: US 2026/0242892 A1
(43) Pub. Date: Aug. 20, 2026

(54) METHODS AND SYSTEMS FOR LEACHING A METAL-BEARING MATERIAL USING SULFINATES

(71) Applicant: FREEPORT MINERALS CORPORATION, Phoenix, AZ (US)

(72) Inventors: Mitchell Catling, Tucson, AZ (US); Margaret Grabnic, San Francisco, CA (US); Chase Zenner, Tucson, AZ (US); Ethan Bailly, Safford, AZ (US); James Jackman, Chandler, AZ (US); Matej Macak, London (GB); Erica Yuh-Ting Tsai, Boston, MA (US); Andrew Bendelsmith, Long Island City, NY (US)

(73) Assignee: FREEPORT MINERALS CORPORATION, Phoenix, AZ (US)

(21) Appl. No.: 19/537,809

(22) Filed: Feb. 12, 2026

Related U.S. Application Data
(60) Provisional application No. 63/758,925, filed on Feb. 14, 2025.
(60) Provisional application No. 63/883,483, filed on Sep. 17, 2025.

(51) Int. Cl. C22B 15/00; C22B 1/16; C22B 3/02

(52) U.S. Cl. CPC C22B 15/0008; C22B 1/16; C22B 3/02; C22B 15/0065

(57) ABSTRACT

A method for leaching a metal-bearing material is provided. The method includes leaching a metal-bearing material, comprising leaching the metal-bearing material with a leaching solution to produce a pregnant leaching solution, wherein the leaching solution comprises a raffinate and a sulfinate compound, wherein the sulfinate compound produces a decomposition product, and wherein the decomposition product interacts with a passivating material at a surface of the metal-bearing material, improving recovery of a metal value from the metal-bearing material.

### CROSS-REFERENCE TO RELATED APPLICATIONS

This application claims priority to and the benefit of U.S. Provisional Patent Application No. 63/758,925 filed Feb. 14, 2025, entitled “Methods and Systems for Leaching a Metal-Bearing Material Using Sulfinates,” and U.S. Provisional Patent Application No. 63/883,483 filed Sep. 17, 2025, entitled “Methods and Systems for Leaching a Metal-Bearing Material Using Sulfinates,” the disclosures of which are incorporated herein by reference in their entireties for all purposes.

### FIELD OF INVENTION

The present invention generally relates to methods and systems for recovering metal values from metal-bearing materials and, more specifically, to leaching methods and systems using sulfinates.

### BACKGROUND

Heap leaching provides a low-cost method of extracting metal values from relatively low-grade metal-bearing materials and has found particular application in the processing of metal-bearing ores. Generally, in traditional heap leaching operations, an ore is mined, crushed, and then transported to a heap location where it is stacked onto an impervious pad. In some operations, the crushed ore goes through a particle size enhancement process called agglomeration to improve leaching efficiency before it is transported to the heap. A suitable solution is dispensed onto the heap, and the resulting leach solution trickles slowly through the heap under the force of gravity to the pad. This pad typically has a sloped base to allow the solution to flow into collection drains for further processing, such as by a conventional, solvent extraction/electrowinning (SX/EW) process or a direct electrowinning (DEW) process.

Once ores have been subject to the energy intensive processes of blasting, crushing, and agglomeration, a high percentage of the contained valuable metal can be extracted by existing leaching methods. While these methods are relatively effective at metal extraction, implementing improvements to traditional processing techniques to increase extraction efficiency is economically advantageous. An improvement of leaching efficiency based on existing leaching methods may entail using reagents other than acids in the leaching process. Various additives have been suggested for use in the leaching process, however many result in operational issues, such as impacting downstream processes. For example, the use of iron in copper leaching is well known to improve the recovery of certain ore bodies, however, iron easily precipitates out of solution, causing permeability issues within the heap. Further, iron impurities within an electrowinning solution can damage electrowinning equipment (e.g. corrosion of cathode or anode plates) and/or decrease the final grade of the plated copper. Introducing sulfinate compounds to the leaching process results in increased leaching efficiency with no impact on downstream processes.

### SUMMARY

A system for leaching a metal-bearing material is provided. In various embodiments, the system includes an agglomeration system, comprising the metal-bearing material comprising a metal value; and an agglomeration solution comprising a raffinate and a sulfinate compound, wherein the agglomeration system is configured to agglomerate the metal-bearing material with the agglomeration solution to form an agglomerated metal-bearing material, and a leaching system comprising the agglomerated metal-bearing material, and a leaching solution comprising the raffinate, wherein the leaching system is configured to leach the agglomerated metal-bearing material to produce a pregnant leaching solution, thereby improving recovery of the metal value from the metal-bearing material. In various embodiments, the sulfinate compound may produce a decomposition product, and the decomposition product may interact with a passivating material at a surface of the metal-bearing material, improving recovery of the metal value from the metal-bearing material.

In various embodiments, the sulfinate compound concentration in the agglomeration solution is about 0.05 lbs/ton to about 5 lbs/ton. In various embodiments, the leaching solution further comprises the sulfinate compound. In various embodiments, the sulfinate compound concentration in the leaching solution is about 0.05 g/L to about 5 g/L. In various embodiments, the sulfinate compound is sodium methane sulfinate or other methane sulfinate salts.

In various embodiments, moisture content of the agglomeration system is optimized to enhance interaction of the decomposition product with the passivating material, wherein optimizing comprises lowering the agglomeration solution volume. In various embodiments, the lowering the agglomeration solution volume produces an agglomeration solution volume that is 75% of a calculated optimum agglomeration solution volume.

In various embodiments, the leaching system is a subsurface leaching system.

In various embodiments, the leaching solution further comprises a lixiviant, wherein the lixiviant comprises at least one of acidic raffinate, sulfuric acid, a dilute sulfuric acid solution, or water.

In various embodiments, the system further comprises forming at least a portion of a heap with the agglomerated metal-bearing material after the agglomerating. In various embodiments, the decomposition product is a sulfonyl radical or an alkyl radical, and wherein the passivating material is a sulfide (e.g., sulfur). In various embodiments, the metal value is copper.

A method for leaching a metal-bearing material is provided. In various embodiments, the method includes leaching a metal-bearing material with a leaching solution to produce a pregnant leaching solution, wherein the leaching solution comprises a raffinate and a sulfinate compound. In various embodiments, the sulfinate compound produces a decomposition product, and the decomposition product interacts with a passivating material at a surface of the metal-bearing material, improving recovery of a metal value from the metal-bearing material.

In various embodiments, the sulfinate compound is added at a concentration of about 0.05 lbs/ton to about 5 lbs/ton. In various embodiments, the sulfinate compound is sodium methane sulfinate or other methane sulfinate salts. In various embodiments, the sulfinate compound concentration in the leaching solution is about 0.05 g/L to about 5 g/L/

In various embodiments, the decomposition product is a sulfonyl radical or an alkyl radical, and wherein the passivating material is a sulfide (e.g., sulfur).

In various embodiments, the method further comprises agglomerating the metal-bearing material with an agglomeration solution prior to the leaching, wherein the agglomeration solution comprises the raffinate.

In various embodiments, the method further includes optimizing moisture content during the agglomeration to enhance interaction of the decomposition product with the passivating material, wherein the optimizing comprises lowering the agglomeration solution volume. In various embodiments, the lowering the agglomeration solution volume produces an agglomeration solution volume that is 75% of a calculated optimum agglomeration solution volume.

### BRIEF DESCRIPTION OF THE DRAWINGS

The subject matter of the present invention is particularly pointed out and distinctly claimed in the concluding portion of the specification. A more complete understanding of the present invention, however, may best be obtained by referring to the detailed description and claims when considered in connection with the drawing figures, wherein like numerals denote like elements and wherein:

FIG. 1 is a flow diagram illustrating a leaching method in accordance with various embodiments of the present invention.

FIG. 2 is a line graph showing the oxidation reduction potential of a leaching operation under various operational conditions.

FIG. 3 is a line graph showing the copper recovery of various leaching systems in accordance with various embodiments of the present invention.

FIG. 4 is a line graph showing the copper recovery of various leaching systems in accordance with various embodiments of the present invention.

### DETAILED DESCRIPTION OF EXEMPLARY EMBODIMENTS

The following description is merely exemplary in nature and is not intended to limit the present invention, its applications, or its uses. It should be understood that throughout the drawings, corresponding reference numerals indicate like or corresponding parts and features. The description of specific examples indicated in various embodiments of the present invention are intended for purposes of illustration only and are not intended to limit the scope of the invention disclosed herein. Moreover, recitation of multiple embodiments having stated features is not intended to exclude other embodiments having additional features or other embodiments incorporating different combinations of the stated features.

Furthermore, the detailed description of various embodiments herein makes reference to the accompanying drawing figures, which show various embodiments by way of illustration. While the embodiments are described in sufficient detail to enable those skilled in the art to practice the invention, it should be understood that other embodiments may be realized and that logical and mechanical changes may be made without departing from the spirit and scope of the present invention. Thus, the detailed description herein is presented for purposes of illustration only and not of limitation. For example, steps or functions recited in descriptions of any method, system, or process may be executed in any order and are not limited to the order presented. Moreover, any of the steps or functions thereof may be outsourced to or performed by one or more third parties. Furthermore, any reference to singular includes plural embodiments, and any reference to more than one component may include a singular embodiment.

The present invention generally relates to methods and systems for recovering metal values from metal-bearing materials and, more specifically, to leaching methods and systems using sulfinate compounds. Various embodiments of the present invention provide a method for recovering metal values through leaching a metal-bearing material, comprising contacting the metal-bearing material with acid to produce an agglomerated metal-bearing material, adding a sulfinate compound to the agglomerated metal-bearing material to form a combined metal-bearing material, contacting the combined metal-bearing material with a raffinate to form a cured metal-bearing material, and leaching the cured metal-bearing material with a leaching solution to produce a pregnant leaching solution, thereby improving recovery of the metal value from the metal-bearing material. In various embodiments, the sulfinate compound may produce a decomposition product, and the decomposition product interacts with a passivating material at a surface of the metal-bearing material, improving recovery of a metal value from the metal-bearing material. In accordance with the various embodiments of the present invention, the disclosed process increases metal value yield compared with conventional methods and systems. Other advantages and benefits of the various embodiments of the present invention include that the disclosed process has no impact on downstream processes.

In another exemplary embodiment, a system for recovering a metal value from a metal-bearing material includes an agglomeration system, comprising the metal-bearing material comprising a metal value; and an agglomeration solution comprising a raffinate and a sulfinate compound, wherein the agglomeration system is configured to agglomerate the metal-bearing material with the agglomeration solution to form an agglomerated metal-bearing material, and a leaching system comprising the agglomerated metal-bearing material, and a leaching solution comprising the raffinate, wherein the leaching system is configured to leach the agglomerated metal-bearing material to produce a pregnant leaching solution. In various embodiments, the sulfinate compound produces a decomposition product, and the decomposition product interacts with a passivating material at a surface of the metal-bearing material, improving recovery of the metal value from the metal-bearing material. In various embodiments, the leaching solution further comprises a lixiviant, wherein the lixiviant comprises at least one of acidic raffinate, sulfuric acid, a dilute sulfuric acid solution, or water.

Examples of metal values include, but are not limited to, copper, nickel, zinc, silver, gold, germanium, lead, arsenic, antimony, chromium, molybdenum, rhenium, tungsten, iron, ruthenium, osmium, cobalt, rhodium, iridium, palladium, platinum, uranium, or rare earth metals. More preferably, the metal values can be copper, nickel, and/or zinc. Most preferably, the metal value is copper.

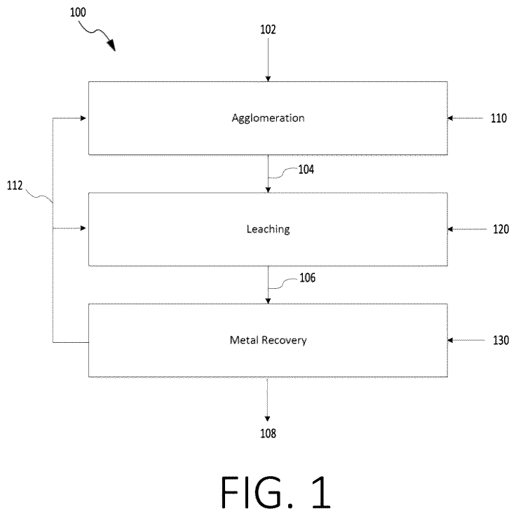

Referring now to FIG. 1, a metal leaching method 100 is illustrated according to various embodiments of the present invention. In accordance with various aspects of the embodiments, a metal-bearing material 102 may be provided for processing from which copper and/or other metal values may be recovered. The metal-bearing material 102 may be an ore, a concentrate, a process residue, or any other material from which metal values may be recovered. Metal values, such as those described herein, may be recovered from the metal-bearing material 102. In an aspect of the present invention, the metal-bearing material 102 may comprise a refractory metal sulfide.

In accordance with various embodiments, the metal-bearing material 102 may comprise chalcocite, pyrite, chalcopyrite, arsenopyrite, bornite, covellite, digenite, cobaltite, enargite, galena, greenockite, millerite, molybdenite, orpiment, pentlandite, pyrrhotite, sphalerite, stibnite, and/or any other suitable metal-bearing ore material. Preferably, the metal-bearing material 102 may comprise primary or secondary sulfides such as chalcocite, bornite, pyrite, covellite, or chalcopyrite, or a blend of such mineral species.

Various aspects and embodiments of the present invention, however, prove especially advantageous in connection with the recovery of copper from copper sulfide ores, such as, for example, chalcopyrite (CuFeS₂), chalcocite (Cu₂S), bornite (Cu₅FeS₄), covellite (CuS), enargite (Cu₃AsS₄), digenite (Cu₉S₅), and mixtures thereof. Thus, the metal-bearing material 102 may be a copper ore or concentrate, and preferably, is a copper sulfide ore or concentrate.

The metal-bearing material 102 may comprise ore in a number of states. Before an ore deposit is mined, the ore is said to be in an in-situ state. During mining, the metal-bearing material 102 may progress through multiple states as it is harvested, collected, transported, and processed. For example, the metal-bearing material 102 as harvested at the mining site may often be referred to as run of mine (or “ROM”) ore. ROM ore may be produced by, for example, blasting, open pit mining, and other surface and subterranean ore extraction techniques. As such, ROM ore includes ore of various sizes from ore as small as powder up to and including boulders.

In an aspect of the present invention, all or a portion of the metal-bearing material 102 may be further processed via size classification and/or crushing to achieve a desired particle size distribution, such that, substantially all of the particles are of a size to allow effective agglomeration of the metal-bearing material 102 and allow for optimal economic recovery of the contained metal values. The agglomerating process 110 may cure the metal-bearing material 102 to form a cured metal-bearing material.

In accordance with various embodiments of the present invention, the metal-bearing material 102 has a particle distribution of any combination of particle distributions. The particle distribution may have a combination of fine and coarse particles. Any particle distribution that maximizes agglomeration and/or curing, and metal recovery is useful. The conditions and parameters of the metal leaching method 100 disclosed herein may be adjusted to achieve an optimized result for leaching and metal recovery.

In accordance with various embodiments, the metal-bearing material 102 is subjected to an agglomerating process 110 to produce an agglomerated metal-bearing material 104. In various embodiments, the agglomerating process 110 may include applying an agglomeration solution to the metal-bearing material 102. In various embodiments, the agglomeration solution may include a raffinate 112 and a sulfinate compound. In various embodiments, the agglomerating process 110 may combine the metal-bearing material 102 with the agglomeration solution to form the agglomerated metal-bearing material 104. In various embodiments, the agglomerating process 110 may cure the metal-bearing material 102 in the agglomeration solution to form a cured metal-bearing material. In various embodiments, curing may render the metal-bearing material 102 amenable to a subsequent leaching process.

As will be appreciated by those skilled in the art, the raffinate 112 and sulfinate compound may be mixed prior to combination with the metal-bearing material 102, such that the agglomeration solution comprises raffinate 112 and a dissolved concentration of the sulfinate compound. In other embodiments, the raffinate 112 and sulfinate compound may be combined with the metal-bearing material 102 separately, such that the agglomeration solution comprises raffinate 112 and is combined with the metal-bearing material 102. After the metal-bearing material 102 has rested in the agglomeration solution for a period of time sufficient to optimize agglomeration and metal recovery and form the agglomerated metal-bearing material, the sulfinate compound may be added to the agglomerated metal-bearing material. The sulfinate compound may be added in any form suitable for combining with the agglomerated metal-bearing material. By way of nonlimiting example, the sulfinate compound may be added in solid form, such as a powder, or liquid form.

In various embodiments, the order of raffinate 112 and sulfinate compound addition may be reversed, such that the sulfinate compound is added to the metal-bearing material 102 first followed by the raffinate 112. In various embodiments, a raffinate provided from any other metal recovery process (not shown) may be used to form the agglomerated metal-bearing material 104. In various embodiments, the raffinate 112 may be an aqueous product of a solvent extraction process, such as, for example, a conventional solvent extraction/electrowinning (SX/EW) process, a direct electrowinning (DEW) process, an ion-exchange (IX) process, and/or a precipitation process. In various embodiments, the raffinate 112 may comprise water and acid. In various embodiments, the raffinate 112 may comprise a concentrated acid only.

In an aspect of the invention, the agglomerating process 110 may involve the metal-bearing material 102 being combined with the raffinate 112 and sulfinate compound in an agglomeration drum. An agglomeration drum may be any suitable agglomeration drum known in the art. In accordance with an exemplary embodiment, the raffinate 112 and sulfinate compound may be combined with the metal-bearing material 102 within the agglomeration drum. The quantity of the raffinate 112 and the quantity of sulfinate compound in the agglomeration solution may vary with respect to the type and/or quantity of metal-bearing material 102 used. In this regard, the raffinate 112 may be mixed with a certain quantity of sulfinate compound to form an agglomeration solution and the agglomeration solution may be optimized during the agglomerating process 110. The metal-bearing material 102 is mixed with the raffinate 112 and sulfinate compound in the agglomeration drum to produce the agglomerated metal-bearing material 104. The agglomerating process 110 may include the blending of coarse portions and fine portions of the metal-bearing material 102, in order to maximize metal recovery while maintaining heap permeability in heap leaching.

In an aspect of the invention, the moisture content of the agglomeration process 110 may be optimized to yield high leaching recoveries. In various embodiments, varying the moisture content in agglomeration, such as, for example, by decreasing the volume of agglomeration solution by weight, may result in higher leaching recoveries. While not being bound by any particular theory, varying moisture content in the agglomeration process 110 may yield higher leaching recoveries as the chemical reaction generated by the sulfinate compound will take place in situ, directly on the surface of the ore, rather than within the raffinate.

In an aspect of the invention, the agglomeration solution may include a certain concentration of sulfinate compound. In various embodiments, the concentration of the sulfinate compound in the agglomeration solution may be adjusted to achieve an optimized result for agglomeration and metal recovery. In various embodiments, the agglomeration solution may comprise a concentration of sulfinate compound in the range of less about 0.05 lbs/ton to about 10 lbs/ton, preferably in the range of about 0.25 lbs/ton to about 5 lbs/ton, more preferably in the range of about 0.4 lbs/ton to about 2.2 lbs/ton.

In an aspect of the invention, the agglomerating process 110 may comprise resting the metal-bearing material 102 in the agglomeration solution for a certain period of time. In various embodiments, the certain period of time may be adjusted to achieve an optimized result for agglomeration and metal recovery. In various embodiments, the metal-bearing material 102 may rest in the agglomeration solution for any duration in the range of about 0 to about 8 days. In various embodiments, the metal-bearing material 102 may rest in the agglomeration solution for any duration in the range of about 0 to about 40 days. In various embodiments, the metal-bearing material 102 may rest in the agglomeration solution for any duration on the order of at least 1 day.

In an aspect of the invention, the agglomerated metal-bearing material 104 may be subjected to a leaching process 120 to produce a pregnant leaching solution 106. In various embodiments, the leaching solution used in the leaching process 120 may comprise the raffinate 112. In various embodiments, the leaching solution may comprise water and acid. In various embodiments, the leaching solution may further comprise the sulfinate compound. In various embodiments, the concentration of the sulfinate compound in the leaching solution may be in the range of about 0.05 g/L to about 5 g/L, preferably in the range of about 0.075 g/L to about 0.5 g/L, more preferably about 0.1 g/L.

In an aspect of the invention, the leaching process 120 may comprise applying the leaching solution to the agglomerated metal-bearing material 104 and resting the agglomerated metal-bearing material 104 in the leaching solution for a certain period of time. In various embodiments, the certain period of time may be adjusted to achieve an optimized result for leaching and metal recovery. In various embodiments, the agglomerated metal-bearing material 104 may rest in the leaching solution for any duration in the range of about 0 to about 40 days. In various embodiments, the agglomerated metal-bearing material 104 may rest in the leaching solution for any duration in the range of about 0 to about 15 days. In various embodiments, the agglomerated metal-bearing material 104 may rest in the leaching solution for any duration on the order of at least 1 day.

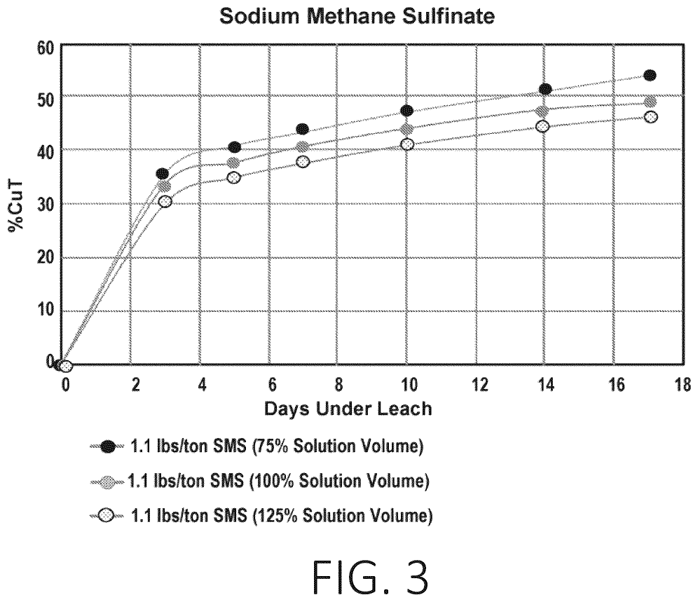

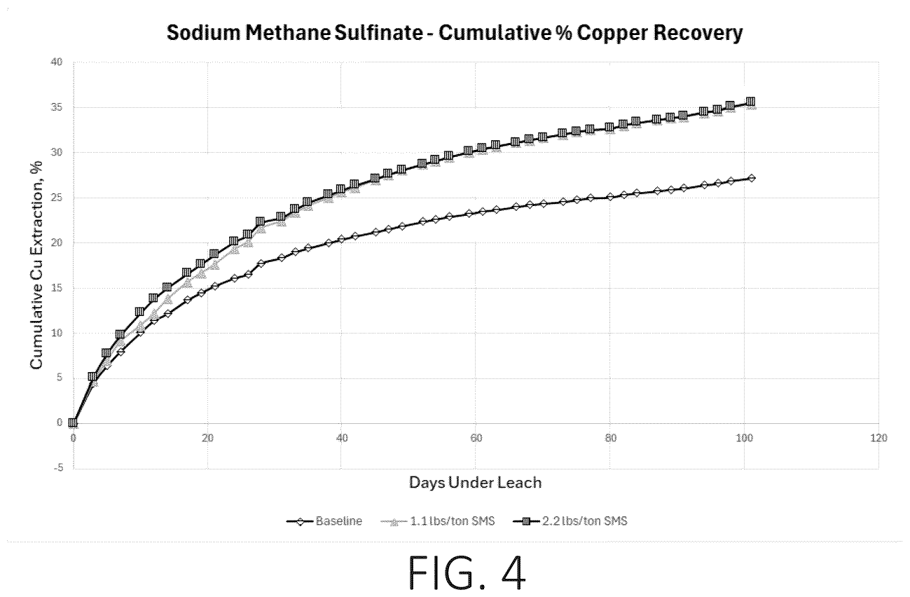

In various embodiments, the sulfinate compound improves recovery of the metal-bearing material 102. As can be seen in FIG. 3 and FIG. 4, copper recovery improves with the addition of SMS. The sulfinate compound may improve recovery of the metal-bearing material 102 by one or more of several mechanisms. In various embodiments, the mechanisms discussed below may operate alone or in tandem, and a leaching process may comprise any number of operative recovery improvement mechanisms at a time. In various embodiments, the sulfinate compound may interact with sulfides (e.g, sulfur) present in the metal-bearing material 102 to form surface sulfur-sulfur bonds or interact with a metal in the mineral lattice of the metal-bearing material 102 to form metal sulfinate bonds. These bonds may be oxidized by a suitable oxidant in the solution, such as, for example, ferric ion, thereby breaking up the mineral matrix of the metal-bearing material 102 and liberating the target metal value.

In various embodiments, the decomposition of the sulfinate compound as it reacts with the metal-bearing material 102 and raffinate may produce at least one beneficial decomposition product. In various embodiments, the at least one beneficial decomposition product may be a sulfonyl radical and/or an alkyl radical, which may interact with the sulfide (e.g., sulfur) at the surface of the metal-bearing material 102. A common issue in metal leaching is passivation, wherein an unreactive layer of material forms over the mineral surface within the metal-bearing material 102, preventing a leaching solution from reaching the metal value contained within and preventing the liberation of the metal value. Sulfur is a common unreactive layer, therefore, by using the sulfur in various chemical processes, such as those with sulfinate compound decomposition products, the mineral surface within the metal-bearing material 102 is exposed, allowing the leaching solution to reach and liberate the metal value. In such embodiments, the agglomerating process 110 may stabilize and/or maximize the ability of the solution and any additives and/or byproducts to contact the surface of the ore. Without being bound to any particular theory, the agglomerating process 110 may enhance the benefits of the produced sulfonyl and/or alkyl radicals, as they are quickly saturated by the agglomeration solution, which may account for the stabilized and/or maximized surface contact.

In various embodiments, the metal-bearing material 102 and/or agglomeration may comprise iron ions. In such embodiments, the sulfinate compound may be oxidized by ferric ions, generating ferrous ions. Ferrous ions may improve leaching processes by lowering the oxidation/reduction potential (ORP), thereby facilitating reductive leaching of some mineral species, including chalcopyrite. Further, ferric ions are prone to precipitation out of solution as goethite, jarosite, or other iron hydroxides causing passivation of the metal-bearing material 102. The consumption of ferric ions by the sulfinate compound may therefore reduce the risk of iron precipitation and therefore surface passivation.

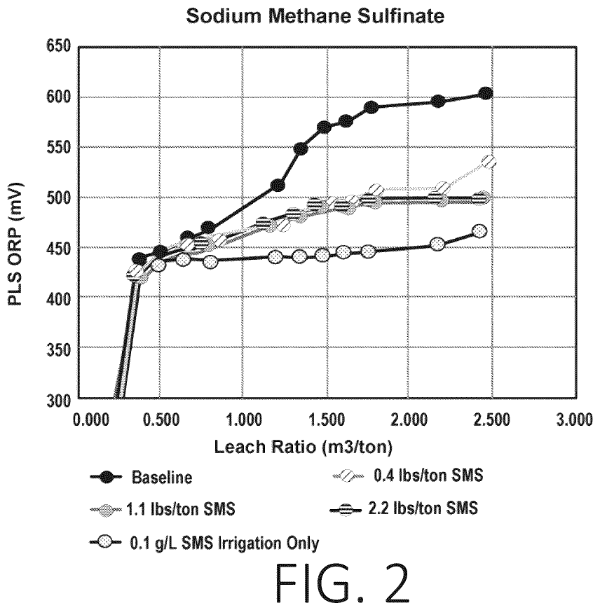

In various embodiments, the sulfinate compound may help control the oxidation reduction potential (ORP) of the leaching process, allowing operators greater control over the conditions within the heap. Too high of an ORP may inhibit leaching and recovery and lead to increased acid consumption, while too low of an ORP may hinder the rate of recovery from some sulfide minerals that require oxidation by ferric ion to leach, such as chalcocite. Throughout the leaching process, ORP naturally increases as ferric ions are produced. As discussed above, the sulfinate compound may consume ferric ions, preventing the overproduction of ferric ions and thereby maintaining the ORP within a desired range. As can be seen in FIG. 2, sulfinate compounds may react with oxidant species present in the raffinate solution, maintaining the ORP within a desired range more effectively than leaching operations not including sulfinate compounds. This ORP buffering effect is particularly evident when the sulfinate compound is added in the leaching solution.

In various embodiments, the sulfinate compound may comprise any sulfinate compound suitable for leaching a metal-bearing material 102. In various embodiments, the sulfinate compound may comprise sulfinate molecules with donating alkyl moieties. In various embodiments, the sulfinate compound may comprise sodium ethanesulfinate, sodium ethyl sulfinate, sodium methane sulfinate, sodium methyl sulfinate, hypotaurine, sodium 3-methoxy-3-oxopropane-1-sulfinate, sodium 3-methoxy-2-methyl-3-oxopropane-1-sulfinate, sodium difluoromethyl sulfinate, cyclopropanesulfinic acid sodium salt, sodium 4-methylbenzenesulfinate, sodium 4-(methoxycarbonyl)benzene-1-sulfinate, and/or other methane sulfinate salts. In various embodiments, the corresponding salts of the sulfinate compound may be mineral salts, such as, for example, mineral salts (e.g., calcium, lithium, phosphorus, sodium, potassium, iron, magnesium, silicon, selenium, manganese, zinc, and copper). While not being bound by any one particular theory, it is thought that sulfinic acid (RSO₂H) derivatives (e.g. sulfinates such as sodium methane sulfinate (SMS)) are more effective at improving leaching recoveries than sulfonic acid (RSO₃H) derivatives (e.g. sulfonates such as methanesulfonic acid (MSA)), as sulfinic acids are the reduced version of sulfonic acids. Therefore, leaching solutions generated from the addition of sulfinic acids to a raffinate will yield a lower ORP than those leaching solutions generated from the additions of sulfonic acids, resulting in improved leaching recoveries comparably.

In an aspect of the invention, the leaching process 120 may comprise heap leaching. In various embodiments, the heap leaching may comprise stacking or forming the agglomerated metal-bearing material 104 into a heap or a portion of a heap. In various embodiments, the heap leaching may comprise leaching the heap with the leaching solution after the heap is formed. In various embodiments, the irrigation rate of the leaching solution onto the heap may be reduced during the initial phase of leaching to improve initial recoveries. While not being bound by any particular theory, reduced irrigation rates may enable the sulfinate compound and its associated decomposition products, such as, for example, a sulfonyl radical and/or an alkyl radical, to react directly at the surface of the ore, rather than within the leaching solution. Reactions at the ore surface improve the exposure of the mineral surface from passivating layers, improving the ability of the leaching solution to contact the mineral surface and extract targeted metals. In an aspect of the invention, the sulfinate compounds may be particularly beneficial in agitate leaching applications. It is also possible that reduced irrigation rates may favor competitive decomposition, thereby reducing productive chemistry at the ore surface.

In another aspect of the invention, the leaching process 120 may comprise any other known leaching method, such as column leaching, shake flask leaching, or tank/agitation leaching. In accordance with one aspect of the present invention, the leach process 120 comprises atmospheric leaching, pressure leaching, whole ore leaching, agitation leaching, heap leaching, stockpile leaching, pad leaching, thin-layer leaching and/or vat leaching, at either ambient or elevated temperatures.

In various embodiments, a system for delivering the leaching solution may generally comprise one or more pipes arranged to deposit leaching solution to the heap, column, tank, flask, or vat (whichever means is used to collect a metal-bearing material). The leaching solution distribution system may be configured in a network arrangement to receive leaching solution from one or more sources and conduct the leaching solution to the metal-bearing material. The leaching solution may be sourced from a variety of locations. Fresh acid and/or water may be used as well as acid and/or water that is recycled or reclaimed from other metal value recovery process, such as raffinate from a solvent extraction/electrowinning (“SXEW”) process. In various embodiments, fresh basic medium and/or water may be used as well as basic medium and/or water that is recycled or reclaimed from other metal value recovery processes. In various embodiments, the leach solution may be enhanced with specific strains of bacteria, air, enriched air, oxygen, chemical oxidants, and/or leach enhancing chemicals. The leaching solution distribution system may be provided these sources of leaching solution and distribute them to the metal-bearing material.

In various embodiments, the metal bearing materials contain oxides, for example, oxides of metal values. For example, copper and cobalt oxides. In various embodiments, electrowinning may comprise an anode configured to enable the electrolyte to flow through it. As used herein, the term “flow-through anode” refers to an anode so configured.

In accordance with various embodiments in which the metal-bearing material is positioned in a heap, the leaching process 120 may comprise a subsurface leaching system. In several embodiments, the system may comprise one or more subsurface injectors. Subsurface injectors may comprise any suitable structure configured to deliver leaching solution at a target operational condition beneath the surface of a heap. In various embodiments, the subsurface leaching system may comprise a first subsurface injector, a second subsurface injector, a third subsurface injector, a fourth subsurface injector, and a fifth subsurface injector, etc. The subsurface leaching system may also suitably comprise more or less than five subsurface injectors, in various embodiments. Subsurface injectors may be fluidly coupled to a primary pipe and/or secondary pipe to receive leaching solution and distribute the leaching solution to desired locations within the heap. Additional information regarding subsurface injection may be found in U.S. Pat. No. 12,378,634, the entire contents of which is incorporated by reference herein. In various embodiments, the leaching process 120 may comprise an agitated tank leach. The agitated tank leach may be performed at constant or varying pH levels. Basic pH levels may range from about 7 to about 14. Leach solutions may contain recycled solutions from upstream processes and recovered lixiviant from various processing steps. Fresh lixiviant may also be added. Leaching may occur in several tanks, either co-currently or counter-currently depending on the leach characteristics and kinetics. Preferably, the duration of leaching in accordance with various aspects of the present invention ranges from about 2 hours to about 8 hours. More preferably, the duration ranges from about 4 hours to about 7 hours.

In an aspect of the invention, the pregnant leaching solution 106 may be subjected to a metal recovery process 130 to produce the metal value 108 and the raffinate 112. In various embodiments, the metal recovery process 130 may comprise a direct electrowinning (DEW) process. In another exemplary embodiment, the metal recovery process 130 may comprise a solvent extraction and electrowinning (SX/EW) process.

In various embodiments, the raffinate 112 may be recirculated and reused in the metal leaching method 100. In various embodiments, the raffinate 112 may be reused in the agglomerating process 110 as a component of the agglomeration solution. In various embodiments, the raffinate 112 may be reused in the leaching process 120 as a component of the leaching solution. In various embodiments, the sulfinate compound may be added to the raffinate 112 to form an agglomeration solution to agglomerate the metal-bearing material 102.

In an aspect of the invention, part or all of the metal leaching method 100 may be carried out under a certain pressure, temperature, and/or maintained at a certain moisture content. In various embodiments, the agglomerating process 110, leaching process 120, and metal recovery process 130 may be carried out under a certain pressure, temperature, and/or maintained at a certain moisture content. In various embodiments, the pressure, temperature, and/or moisture content may be adjusted to achieve an optimized result for agglomeration, leaching, and/or metal recovery. In various embodiments, leaching method 100 may be carried out at ambient temperatures, such as, for example, in an autoclave leaching process.

In various embodiments, the agglomerating process 110, leaching process 120, and/or metal recovery process 130 may be carried out under an atmospheric pressure. In various embodiments, the agglomerating process 110, leaching process 120, and/or metal recovery process 130 may be carried out under another pressure. In various embodiments, the agglomerating process 110, leaching process 120, and/or metal recovery process 130 may be carried out under an ambient temperature, such as 20-22° C. In various embodiments, the agglomerating process 110, leaching process 120, and/or metal recovery process 130 may be carried out under another temperature, such as 0-60° C.

In various embodiments, the agglomerating process 110, leaching process 120, and/or metal recovery process 130 may be carried out in an optimum volume of solution as determined sufficient by the unique ore type, correlating to a standard moisture content. In various embodiments, the agglomerating process 110, leaching process 120, and/or metal recovery process 130 may be carried out in another volume of solution, varying moisture content, such as, for example a volume of solution that is 50%-150% of the optimum volume, resulting in a lower or higher moisture content respectively when compared to the standard moisture content.

The Examples set forth herein are illustrative of exemplary embodiments of the present invention. The process, conditions and parameters reflected therein are intended to exemplify various aspects of the invention and are not intended to limit the scope of the claimed invention.

### Example 1

A specimen of copper-containing ore was subject to a leaching method disclosed in the present invention. The ore contained approximately 0.13% by weight of copper minerals, of which comprised the following concentrations: 1% of chalcocite, 90% of chalcopyrite, 2% of covellite, 2% of copper-bearing biotite, and 6% of other types of copper-bearing materials. First, approximately 12 pounds of ore was added to an agglomeration drum, followed by 16 lbs/ton of concentrated sulfuric acid. After an initial mixing phase of 60 seconds, a solid form of a sulfinate compound (sodium methane sulfinate (SMS)) was added at the concentrations shown in Table 1. This mixture was allowed to agglomerate for another 30 seconds before the addition of a raffinate solution. The mixture was then mixed for a final 60 seconds in the agglomeration drum. The agglomeration solution contains a raffinate produced from a copper leaching process. The concentration of SMS in agglomeration was varied to show the impact of concentration on copper recovery. Next, the agglomerated ore was allowed to cure in a leaching column for 24 hours to produce a cured ore. Following that, the agglomerated ore was leached in a leaching column for 60 days under an atmospheric pressure at 20-22° C. to produce a pregnant leaching solution. The leaching solution contains the same raffinate. The pregnant leach solution was collected from the ore through a drain on the bottom of the column and assayed to determine extracted metal concentration.

The following leaching trials were carried out, as listed in Table 1. Except those conditions and reagents described below and listed in Table 1, each leaching trial was conducted under the same conditions with the same reagents.

TABLE 1
Conditions and Cu Recovery Rates of Four Leaching Trials

| Trial No. | SMS (lbs/ton) | Cu Recovery (%) |
|---|---|---|
| 1 | 0 | 8.4 |
| 2 | 0.4 | 12.1 |
| 3 | 1.1 | 14.8 |
| 4 | 2.2 | 17.0 |

As can be seen in Table 1, copper recovery improves with the addition of SMS, with recoveries of around 8% higher than the trial containing only raffinate and no SMS. This corresponds to a 104% increase in copper recovery.

### Example 2

Another specimen of the same copper-containing ore used in Example 1 was subject to a leaching method disclosed in the present invention. The experimental conditions, methodology, and tested reagents were identical to those in Example 1 except for the method in which SMS was added into the test. In Trial 1, no SMS was added, in Trial 2, SMS was combined with the leaching solution before contacting the ore, and in Trial 3, the SMS was added directly to the ore in a solid form during the agglomeration process (as detailed in Example 1).

TABLE 2
Conditions and Cu Recovery Rates of Three Leaching Trials

| | | |
|---|---|---|
| Trial No. | SMS | Cu Recovery (%) |

| 1 | 0 | | 8.4 |
|---|---|---|---|
| 2 | 0.1 | g/L | 12.0 |
| 3 | 2.2 | lbs/ton | 14.8 |

As can be seen in Table 2, SMS is more effective when added into the agglomeration process rather than when it is added in the leaching solution directly. While not being bound by any particular theory, this may be because sulfinates increase recovery of the metal from the sulfidic minerals through a radical mechanism and are therefore unstable when prepared in raffinate solution prior to addition, as they will being to react with oxygen in air, and therefore degrade prior to reaction with the ore. As sulfinates sit in solution without contacting another compound, they begin to break down. Therefore, sulfinates are more effective when added in agglomeration, as they will be able to quickly contact and interact with the metal-bearing material prior to degrading in the raffinate solution.

However, as noted above and shown in FIG. 2, sulfinates may help control the ORP of a leaching operation. This effect is particularly evident when the sulfinate compound is added to the leaching solution. Therefore, the sulfinate compound may be added in both the agglomeration solution and the leaching solution to improve both recovery and control the ORP.

### Example 3

Several specimens of copper-containing ore were subjected to a leaching method in accordance with the present disclosure. Trial 1 used ore that contained approximately 0.25% by weight of copper minerals, of which comprised the following concentrations: 50% of chalcocite, 15% of chalcopyrite, 20% of covellite, 5% of copper-bearing biotite, and 10% of other types of copper-bearing materials. Trial 2 used ore that contained approximately 0.14% by weight of copper minerals, of which comprised the following concentrations: 9% of chalcocite, 52% of chalcopyrite, 15% of covellite, 4% chrysocolla, 3% bornite, and 6% copper bearing clays, and 11% other types of copper-bearing materials. Trial 3 used ore that contained approximately 0.12% by weight of copper minerals, of which comprised the following concentrations: 90% of chalcopyrite, 2% of covellite, 2% bornite, 3% of copper-bearing clays, and 3% of other types of copper-bearing materials.

In a first step of the process, 25 grams of 100 Tyler mesh ore was added to 125 mL solution comprising a raffinate produced from a copper leaching process and the sulfinate compound. The concentration of sulfinate compound in the raffinate was 10 molar equivalents to the molar amount of copper concentration in the ore. The ore was leached for 24 hours in a 250 mL shake flask under atmospheric pressure at 30° C. to produce a pregnant leach solution. The pregnant leach solution was separated from the ore by a filtration process and assayed to determine extracted metal concentration.

The following four sulfinate compounds were tested for each of the three trials, along with a baseline test containing no sulfinate compound within the solution. Except those conditions and reagents described below and listed in Table 1, each leaching operation was conducted under the same conditions with the same reagents.

TABLE 3
Conditions and Cu Recovery Rates of Three Leaching Trials

| | Trial 1 (Cu | Trial 2 (Cu | Trial 3 (Cu |
|---|---|---|---|
| Sulfinate Compound | Recovery %) | Recovery %) | Recovery %) |
| Baseline (No Compound) | 38 | 21 | 5 |
| Sodium ethyl sulfinate | 79 | — | 96 |
| Sodium methyl sulfinate | 91 | 93 | 95 |
| Hypotaurine | 90 | 88 | 92 |
| Sodium 3-ethoxy-3- | 78 | 75 | 71 |
| oxopropane-1-sulfinate | | | |

As can be seen in Table 3, a variety of sulfinate compounds with donating alkyl moieties are effective in improving copper recovery across multiple ore types, allowing the methods and systems disclosed in the present invention to have widespread application within the mining industry.

### Example 4

Several specimens of copper-containing ore were subjected to a leaching method in accordance with the present disclosure. First, approximately 12 pounds of ore was added to an agglomeration drum, followed by 16 lbs/ton of concentrated sulfuric acid. After an initial mixing phase of 60 seconds, a solid form of a sulfinate compound (sodium methane sulfinate (SMS)) was added at a concentration of 1.1 lbs/ton. This mixture was allowed to agglomerate for another 30 seconds before the addition of a raffinate solution. The mixture was then agglomerated for a final 60 seconds in the agglomeration drum. The agglomeration solution contains a raffinate produced from a copper leaching process, and its volume (as detailed in Table 4) was varied to show the impact of moisture content in agglomeration on copper recovery. Next, the agglomerated ore was allowed to cure in a leaching column for 24 hours to produce an agglomerated ore. Following that, the agglomerated ore was leached in a leaching column for 17 days under an atmospheric pressure at 20-22° C. to produce a pregnant leaching solution. The leaching solution contains the same raffinate. The pregnant leach solution was collected from the ore through a drain on the bottom of the column and assayed to determine extracted metal concentration.

The following leaching trials were carried out, as listed in Table 4. Except those conditions and reagents described below and listed in Table 4, each leaching trial was conducted under the same conditions with the same reagents.

TABLE 4
Conditions and Cu Recovery Rates of Three Leaching Trials

| Trial No. | Agglomeration Solution Volume | Cu Recovery (%) |
|---|---|---|
| 1 | 75% | 54.0 |
| 2 | 100% | 48.7 |
| 3 | 125% | 46.2 |

As can be seen in Table 4 and corresponding FIG. 3, which is a graphical illustration of the data in Table 4, the copper recovery was highest when the agglomeration process was conducted in a lower volume of solution. While not being bound to any particular theory, a lower volume of solution in the agglomeration process 110 may yield higher leaching recoveries due to production of a decomposition product formed by the reaction of the sulfinate compound with the ore and raffinate. The decomposition product may be a sulfonyl radical and/or an alkyl radical, which, while not being bound to any particular theory may interact with the sulfide (e.g., sulfur) at the surface of the ore, exposing any mineral surface passivated or covered by the sulfide (e.g., sulfur). When moisture content is varied, the sulfonyl and/or alkyl radical reactions are more likely to take place in situ, directly on the surface of the ore, rather than within the raffinate. Additionally, the above data suggests that in various embodiments, it may be beneficial to reduce the irrigation rate on the leach heap during the initial phase of leaching to improve initial recoveries.

### Example 5

A specimen of copper-containing ore was subjected to a leaching method in accordance with the present disclosure. The ore contained approximately 0.44% by weight of copper minerals, of which comprised the following concentrations: 10% of chalcocite, 48% of chalcopyrite, 3% of covellite, 35% of copper-bearing biotite, and 4% of other types of copper-bearing materials. First, approximately 12 pounds of ore was added to an agglomeration drum, followed by 13 lbs/ton of concentrated sulfuric acid. After an initial mixing phase of 60 seconds, a solid form of a sulfinate compound (sodium methane sulfinate (SMS)) was added to the drum at the concentrations shown in Table 1. This mixture was allowed to agglomerate for another 30 seconds before the addition of a raffinate solution. The mixture was then mixed for a final 60 seconds in the drum before being transferred to a column. The agglomeration solution contains a raffinate produced from a copper leaching process. The concentration of SMS in agglomeration was varied to show the impact of concentration on copper recovery. Next, the agglomerated ore was allowed to cure in a leaching column for 72 hours to produce a cured ore. Following that, the agglomerated ore was leached in a leaching column for 89 days under an atmospheric pressure at 20-22° C. to produce a pregnant leaching solution. The leaching solution contains the same raffinate. The pregnant leach solution was collected from the ore via a drain on the bottom of the column and assayed to determine extracted metal concentration.

The following leaching trials were carried out, as listed in Table 1. Except those conditions and reagents described below and listed in Table 1, each leaching trial was conducted under the same conditions with the same reagents.

TABLE 5
Conditions and Cu Recovery Rates of Three Leaching Trials

| Trial No. | SMS (lbs/ton) | Cu Recovery (%) |
|---|---|---|
| 1 | 0 | 25.9 |
| 2 | 1.1 | 33.8 |
| 3 | 2.2 | 33.9 |

As can be seen in Table 5, and corresponding to FIG. 4, copper recovery improves with the addition of SMS, with recoveries of around 8% higher than the trial containing only raffinate and no SMS. This corresponds to a 31% increase in copper recovery. These results show that adding SMS during agglomeration improves copper recovery in the leaching process, demonstrating that SMS is effective not only when added directly to the raffinate during the leaching step, but also when combined with the ore in agglomeration.

As discussed above, the present invention includes a metal leaching method utilizing sulfinate compounds to improve the efficiency of metal extraction operations. The present invention has been described with reference to various exemplary embodiments. However, many changes, combinations, and modifications may be made to the exemplary embodiments without departing from the scope of the present invention. For example, the various components may be implemented in alternate ways. These alternatives can be suitably selected depending upon the particular application or in consideration of any number of factors associated with the operation of the system. In addition, the techniques described herein may be extended or modified for use with other metal extraction processes. These and other changes or modifications are intended to be included within the scope of the present claims.

The present invention has been described above with reference to a number of exemplary embodiments. It should be appreciated that the particular embodiments shown and described herein are illustrative of the invention and its best mode and are not intended to limit in any way the scope of the invention as set forth in the claims. Those skilled in the art having read this disclosure will recognize that changes and modifications may be made to the exemplary embodiments without departing from the scope of the present invention. For example, various aspects and embodiments of this invention may be applied to recovery of metals other than copper, such as nickel, zinc, cobalt, and others. Although certain preferred aspects of the invention are described herein in terms of exemplary embodiments, such aspects of the invention may be achieved through any number of suitable means now known or hereafter devised. Accordingly, these and other changes or modifications are intended to be included within the scope of the present invention.

It is believed that the disclosure set forth above encompasses at least one distinct invention with independent utility. While the invention has been disclosed in the exemplary forms, the specific embodiments thereof as disclosed and illustrated herein are not to be considered in a limiting sense as numerous variations are possible. Equivalent changes, modifications and variations of various embodiments, materials, compositions, and methods may be made within the scope of the present invention, with substantially similar results. The subject matter of the inventions includes all novel and non-obvious combinations and sub combinations of the various elements, features, functions, and/or properties disclosed herein.

Benefits, other advantages, and solutions to problems have been described herein with regard to specific embodiments. However, the benefits, advantages, solutions to problems, and any element or combination of elements that may cause any benefit, advantage, or solution to occur or become more pronounced are not to be construed as critical, required, or essential features or elements of any or all the claims or the invention. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above.

What is claimed is:

1. A system for leaching a metal-bearing material, comprising:
an agglomeration system, comprising:
the metal-bearing material comprising a metal value; and
an agglomeration solution comprising a raffinate and a sulfinate compound;
wherein the agglomeration system is configured to agglomerate the metal-bearing material with the agglomeration solution to form an agglomerated metal-bearing material; and
a leaching system comprising:
the agglomerated metal-bearing material; and
a leaching solution comprising the raffinate;
wherein the leaching system is configured to leach the agglomerated metal-bearing material to produce a pregnant leaching solution;
wherein the sulfinate compound produces a decomposition product, and wherein the decomposition product interacts with a passivating material at a surface of the metal-bearing material, improving recovery of the metal value from the metal-bearing material.

2. The system of claim 1, wherein the sulfinate compound concentration in the agglomeration solution is about 0.05 lbs/ton to about 5 lbs/ton.

3. The system of claim 1, where in the leaching solution further comprises the sulfinate compound.

4. The system of claim 3, wherein the sulfinate compound concentration in the leaching solution is about 0.05 g/L to about 5 g/L.

5. The system of claim 1, wherein the sulfinate compound is sodium methane sulfinate or other methane sulfinate salts.

6. The system of claim 1, wherein moisture content of the agglomeration system is optimized to enhance interaction of the decomposition product with the passivating material, wherein optimizing comprises lowering the agglomeration solution volume.

7. The system of claim 6, wherein the lowering the agglomeration solution volume produces an agglomeration solution volume that is 75% of a calculated optimum agglomeration solution volume.

8. The system of claim 1, wherein the leaching system is a subsurface leaching system.

9. The system of claim 1, wherein the leaching solution further comprises a lixiviant, wherein the lixiviant comprises at least one of acidic raffinate, sulfuric acid, a dilute sulfuric acid solution, or water.

10. The system of claim 1, further comprising forming at least a portion of a heap with the agglomerated metal-bearing material after the agglomerating.

11. The system of claim 1, wherein the decomposition product is a sulfonyl radical or an alkyl radical, and wherein the passivating material is a sulfide.

12. The system of claim 1, wherein the metal value is copper.

13. A method for leaching a metal-bearing material, comprising:
leaching the metal-bearing material with a leaching solution to produce a pregnant leaching solution, wherein the leaching solution comprises a raffinate and a sulfinate compound;
wherein the sulfinate compound produces a decomposition product, and wherein the decomposition product interacts with a passivating material at a surface of the metal-bearing material, improving recovery of a metal value from the metal-bearing material.

14. The method of claim 13, wherein the sulfinate compound is added at a concentration of about 0.05 lbs/ton to about 5 lbs/ton.

15. The method of claim 13, wherein the sulfinate compound is sodium methane sulfinate or other methane sulfinate salts.

16. The method of claim 13, wherein the sulfinate compound concentration in the leaching solution is about 0.05 g/L to about 5 g/L.

17. The method of claim 13, wherein the decomposition product is a sulfonyl radical or an alkyl radical, and wherein the passivating material is a sulfide.

18. The method of claim 13, further comprising agglomerating the metal-bearing material with an agglomeration solution prior to the leaching, wherein the agglomeration solution comprises the raffinate.

19. The method of claim 18, further comprising:
optimizing moisture content during the agglomerating to enhance interaction of the decomposition product with the passivating material, wherein the optimizing comprises lowering the agglomeration solution volume.

20. The method of claim 19, wherein the lowering the agglomeration solution volume produces an agglomeration solution volume that is 75% of a calculated optimum agglomeration solution volume.
